(19) United States
(12) Patent Application Publication
(10) Pub. No.: US 2022/0263158 A1
(43) Pub. Date: Aug. 18, 2022

(54) BATTERY

(71) Applicant: Volkswagen Aktiengesellschaft, Wolfsburg (DE)

(72) Inventors: Rudolf PAPE, Braunschweig (DE); Bastian SCHAAR, Braunschweig (DE)

(73) Assignee: Volkswagen Aktiengesellschaft, Wolfsburg (DE)

(21) Appl. No.: 17/674,175

(22) Filed: Feb. 17, 2022

(30) Foreign Application Priority Data
Feb. 17, 2021 (DE) 10 2021 201 496.8

(51) Int. Cl. H01M 10/6556; H01M 10/613; H01M 10/625

(52) U.S. Cl. CPC H01M 10/6556; H01M 2220/20; H01M 10/625; H01M 10/613

(57) ABSTRACT

A battery comprises a cell stack that encompasses layers stacked above each other in a stacking direction, whereby the layers consist alternately of an electrode or of a separator. At least one of the electrodes that is arranged between the ends of the cell stack protrudes beyond the remaining electrodes on one side perpendicular to the stacking direction, and said protruding electrode is thermally contacted with a cooling element that is arranged parallel to the stacking direction and next to the cell stack. A battery module has several such batteries.

### CROSS REFERENCE TO RELATED APPLICATION

This application claims priority from German Patent Application No. 10 2021 201 496.8, filed Feb. 17, 2021, which is hereby incorporated by reference in its entirety.

### FIELD OF THE INVENTION

The invention relates to a battery comprising a cell stack that encompasses layers stacked above each other in a stacking direction, whereby the layers consist alternately of an electrode or of a separator. The invention also relates to a battery module having several batteries.

### SUMMARY OF THE INVENTION

To an increasing extent, motor vehicles are powered, at least partially, by means of an electric motor, meaning that they are configured as electric vehicles or as hybrid vehicles. The power supply of the electric motor is normally obtained from a high-voltage battery that comprises several individual battery modules. For the most part, the battery modules have an identical design, and they are electrically connected to each other in series and/or in parallel, so that the electric voltage present at the high-voltage battery corresponds to a multiple of the electric voltage supplied by each of the battery modules. Each battery module, in turn, comprises several batteries that are normally arranged in a shared module housing and that are electrically connected to each other in series and/or in parallel.

Each one of the batteries, in turn, normally comprises several battery cells, which are also referred to as a galvanic element. Each one of these cells has two electrodes, namely an anode and a cathode as well as a separator arranged between them, and also an electrolyte with freely moving charge carriers. A liquid, for example, is employed as such an electrolyte. In an alternative, the battery is configured as a solid-state battery and the electrolyte is present as a solid. The anode and the cathode that form the electrodes of the battery normally comprise a carrier that functions as a current arrester. An active material which is a constituent of a layer applied onto the carrier, also referred to as an arrester, is affixed thereto. In this context, the electrolyte can already be present in the layer, or else it can be introduced subsequently. However, at least the active material is suitable for receiving the working ions, for instance, lithium ions. Depending on the application as either an anode or as a cathode, a different material is employed for the carrier and a different type of material is used for the layer.

For their protection, the battery cells are usually arranged in a housing of the battery. The housing additionally protects the electrolyte against environmental effects. There are usually several battery cells, normally up to 100 units, installed in the shared housing so that the battery can provide a relatively large capacity. In order to utilize the available space relatively efficiently and to simplify production, the individual components of the appertaining battery cells are configured so as to be flat and are stacked above each other in a stacking direction. The individual battery cells, in turn, are stacked above each other in the stacking direction, so that an essentially cuboidal cell stack is formed. As an alternative, wound configurations of the electrodes inside the battery are also widespread.

Electric energy is fed into or drawn from the individual battery cells of the cell stack during operation of the battery. In this context, the losses that occur cause the cell stack to warm up, and this increases along with the amount of energy that is either fed in or drawn out. For the most part, the cell stack is thermally contacted with the housing on the opposite end faces, so that the cell stack can be cooled off via the housing. As a result of this, however, the battery cells associated with the end faces undergo greater cooling, whereas the battery cells located in the middle of the cell stack are cooled off to a relatively small extent. Therefore, a temperature gradient arises inside of the cell stack, and this can lead to mechanical stresses or at least it diminishes the efficiency of the battery. Moreover, this can translate into non-uniform ageing inside the battery. For this reason, the length of the cell stack in the stacking direction is usually limited, so that the battery cells situated in the middle can be sufficiently cooled. As a result, the capacity of the battery is reduced, and several batteries are needed per battery module in order to supply a certain capacity. Since in this case, each battery has its own housing, the weight of the battery module increases, and the energy density drops.

### SUMMARY OF THE INVENTION

The invention has the objective of putting forward a particularly well-suited battery and a particularly well-suited battery module, whereby advantageously the energy density is increased and/or the weight is reduced.

This objective is achieved according to the invention by means of the features of the battery, and by means of the features of the battery module. Advantageous refinements and embodiments are the subject matter of the appertaining subordinate claims.

Preferably, when the battery is in its proper state, it is a component of a motor vehicle. The battery is suitable, especially provided, and configured towards this end. In its proper state, the battery is, for instance, a component of an energy storage means of the motor vehicle comprising several such batteries. In this context, the batteries are preferably distributed over several battery modules which, in turn, have an identical design. In particular, the batteries are arranged in a housing of the energy storage means or of the appertaining battery module and are electrically connected to each other in parallel and/or in series. Therefore, the electric voltage present at the energy storage means or at the battery module corresponds to a multiple of the electric voltage supplied by each of the batteries. In an advantageous manner, all of the batteries here have an identical design, thus simplifying their production.

The housing of the energy storage means or of the appertaining battery module is preferably made of a metal, for example, a steel such as stainless steel, or an aluminum alloy. A high-pressure die casting method, for example, is used for its production. In particular, the housing of the energy storage means or of the appertaining battery module has a closed configuration. Advantageously, an interface is installed in the housing of the energy storage means or of the appertaining battery module in order to create a connection for the energy storage means or for the battery module. In this context, electric contact is established between the interface and the battery, so that electric energy can be fed into and/or drawn from the batteries from outside of the energy storage means, provided that an appropriate plug has been inserted into the connection.

The motor vehicle is preferably a land vehicle and preferably has a number of wheels of which at least one, preferably several or all of them, are powered by a drive. In a suitable manner, one, preferably several, of the wheels are configured so that they can be steered. This makes it possible to move the vehicle independently of a prescribed surface such as, for instance, rails or the like. In this context, it is advantageously possible to position the motor vehicle essentially on any desired road surface which is preferably made of asphalt, tar or concrete. The motor vehicle is, for example, a utility vehicle such as a truck or a bus. Especially preferably, however, the motor vehicle is a passenger car.

The locomotion of the motor vehicle is advantageously achieved by means of the drive. For instance, the drive, especially the main drive, is configured so as to be at least partially electric, and the motor vehicle is, for example, an electric vehicle. The electric motor is operated, for instance, by means of the energy storage means that is suitably configured as a high-voltage battery. The high-voltage battery advantageously provides electric direct voltage, whereby the electric voltage ranges, for example, from 200 volts to 800 volts, and is essentially 400 volts by way of an example. Preferably, an electric converter is arranged between the energy storage means and the electric motor and it serves to energize the electric motor. In an alternative, the drive additionally has an internal combustion engine so that the motor vehicle is configured as a hybrid vehicle. In an alternative, the energy storage means supplies a low-voltage on-board system of the motor vehicle, and it also especially provides electric direct voltage of 12 volts, 24 volts or 48 volts.

In another alternative, the battery is a component of a forklift truck, an industrial installation or a handheld device such as, for instance, a tool, especially a cordless electric screwdriver. In another alternative, the battery is a component of an energy supply unit and is employed, for example, as a so-called buffer battery. In another alternative, the battery is a component of a portable device, e.g., a portable mobile telephone, or another wearable. It is likewise possible to use such a battery in the realms of camping and model building or for other outdoor activities.

The battery comprises a cell stack which is especially also referred to as an electrode stack. The cell stack comprises several layers stacked above each other in a stacking direction, thus having two ends that are opposite from each other in the stacking direction, in other words, there are two end faces. In this context, the two ends are each formed by means of one of the layers. The layers are advantageously flat, especially planar, and are advantageously arranged perpendicular to the stacking direction. The layers are advantageously rectangular, so that the cell stack is essentially cuboidal. As a result, it can be placed into a cuboidal housing without requiring a lot of space, so that a cuboidal battery can be provided. This allows a relatively efficient arrangement with additional batteries to form, for example, a battery module. In particular, the battery is thus configured as a so-called prismatic battery.

The layers are made up of electrodes and separators. In other words, each one of the layers is either an electrode or a separator, so that the cell stack has several electrodes and several separators. The electrodes in this context are each configured either as an anode or as a cathode. The electrodes and the separators are arranged alternately in the stacking direction so that first one of the separators, then one of the electrodes, again one of the separators, and again one of the electrodes are arranged in the stacking direction. In this context, the two electrodes differ from each other so that, in each case, one of the cathodes is arranged between two anodes.

The separators are identical, for example, in the stacking direction; in other words, they are especially made of the same material. As an alternative to this, the material of the individual separators differs and there are, for instance, two different types of separators, which likewise alternate in the stacking direction. Preferably, the cell stack also comprises an electrolyte which, for example, is solid or liquid.

In this manner, a battery cell is formed which consists of at least three of the layers, preferably four of the layers, that are stacked above each other in the stacking direction, and which can especially also be referred to as an electrode layer. Each of the battery cells has two of the electrodes as well as one or two of the separators. In this context, the two electrodes of each battery differ so that each battery cell has an anode and a cathode between which the appertaining separator is installed. Therefore, the individual battery cells are stacked above each other in the stacking direction in order to form the cell stack, whereby, if the battery cells comprise only three layers, there is still an additional one of the layers, namely, of the appertaining separator. Preferably, the cell stack comprises between 10 layers and 1000 layers, between 20 layers and 50 layers, between 50 layers and 100 layers, between 100 layers and 500 layers or between 120 layers and 200 layers. Therefore, the cell stack especially comprises up to 50 battery cells.

The battery also comprises a cooling element that is arranged parallel to the stacking direction. For instance, a part of the cooling element or else all of it is completely arranged parallel to the stacking direction so that the axis of the longest extension is parallel to the stacking direction. In particular, the cooling element is at least partially cuboidal, thereby facilitating its alignment. Moreover, the cooling element is situated next to the cell stack, in other words, offset perpendicular to it relative to the stacking direction. In particular, when the cooling element is projected perpendicularly onto the cell stack, it covers the cell stack relative to the stacking direction or vice versa.

One of the electrodes that is arranged between the ends of the cell stack protrudes beyond the remaining electrodes on one side perpendicular to the stacking direction, whereby the protruding portion is advantageously located on the side facing the cooling element. For example, the protruding electrode is enlarged in its entirety, so that it especially has an enlarged size. It is particularly preferred if all of the electrodes are essentially rectangular, whereby one of the edges of the protruding electrode is offset, so that two edges of this electrode that are situated opposite from each other are lengthened in comparison to the remaining electrodes. As an alternative, this electrode is offset relative to the remaining electrodes, so that it is not arranged flush or overlapping in the stacking direction. For instance, the remaining electrodes are arranged so as to overlap each other in the stacking direction.

The protruding electrode is thermally contacted with the cooling element. Here, especially the protruding portion of the protruding electrode is thermally contacted with the cooling element via the remaining electrodes, preferably via the edge of the protruding portion situated opposite from the rest of the cell stack. For example, another component, like a heat-conducting paste, is arranged between the protruding electrode and the cooling element. Especially preferably, however, the protruding electrode is mechanically in direct contact with the cooling element, preferably with the protruding portion. This makes it easier to establish the thermal contacting. Especially preferably, the protruding electrode is additionally electrically contacted with the cooling element, thereby facilitating its production. This also yields a relatively efficient thermal contacting. The remaining electrodes, in contrast, are at a distance from the cooling element and therefore are not in thermal contact with it.

Due to the thermal contacting of the protruding electrode, which is situated between the ends, heat is dissipated from the interior of the cell stack and to the cooling element, so that it is not only the ends of the cell stack that are cooled, for example, through convection or by means of another cooling element arranged there. Therefore, it is possible to increase the length of the cell stack in the stacking direction, so that the battery has an increased number of battery cells. This increases the energy density of the battery, thus also reducing the weight. Nevertheless, reliable operation is ensured since heat can be dissipated from the interior of the battery during operation.

The remaining electrodes are at a suitable distance from the cooling element and consequently not thermally contacted with it. Therefore, the cooling element can be made of an electrically conductive material, and this simplifies the heat dissipation. In this context, a physical and consequently also electric contacting of the protruding electrode with the cooling element is possible without causing an electric short circuit with the remaining electrodes. Preferably, at least one of the ends, for instance, both ends, of the cell stack are each thermally contacted with another cooling element so that the heat dissipation is improved.

In a suitable manner, several of the electrodes have a protruding portion so that several protruding electrodes are present which protrude beyond the remaining electrodes perpendicular to the stacking direction on one side and which are thermally contacted with the cooling element. This improves the heat dissipation from the cell stack. In this context, the protruding electrodes are suitably designed identically to each other so that identical parts can be used, thereby reducing the production costs. For example, the protruding electrode or all of the protruding electrodes are configured as an anode so that, as matter of principle, no material can accumulate on the protruding portion during operation of the battery.

Especially preferably, every second electrode in the stacking direction protrudes beyond the remaining electrodes on one side perpendicular to the stacking direction and is thermally contacted with the body. Here, the protruding electrodes are preferably electrically contacted with the cooling element, so that the heat dissipation is improved. For this reason, every second electrode has the same electric potential so that all of the battery cells are electrically connected to each other in parallel. Consequently, the heat is dissipated onto the cooling element via half of the total number of electrodes present, so that the cell stack essentially displays no temperature gradient, and the battery can therefore also be operated in an operating state in which more losses occur such as, for instance, during rapid charging or discharging.

For instance, the separators are congruent with the remaining electrodes. This translates into a relatively low demand for material. Especially preferably, however, the separators that are directly adjacent to the protruding electrodes, in other words, the separators that surround the protruding electrodes in the stacking direction, protrude beyond the remaining electrodes on one side, especially on the same side on which the protruding electrode is also protruding. As a result, these separators prevent an electric short circuit of the protruding electrode with the adjacent remaining electrodes. Moreover, the separators prevent material from accumulating on the protruding electrode in the area of the protruding portion during operation. For example, the separators extend all the way to the cooling element. Especially preferably, however, the protruding portion of the separators is smaller in comparison to the protruding portion of the protruding electrode. This reduces the demand for material. If every second electrode has the protruding portion, preferably all of the separators likewise have the protruding portion.

The electrodes preferably comprise a metal arrester, which is also referred to as a carrier. It is made of a metal and provided with an active material, whereby the active material is advantageously present on both sides of the arrester in the stacking direction. The active material serves to receive working ions such as lithium ions and is suitable, especially provided and configured for this purpose. The active material used is, for instance, a lithium metal oxide such as lithium-cobalt(III)-oxide (LiCoO₂), NMC, NCA, LFP, GIC, LTO. As an alternative, NMC622 or NMC811 is used as the active material. For example, the active materials of the anode and of the cathode differ, whereby, in a suitable manner, the same active material or, in each case, time a different active material is used for each of the anodes and for each of the cathodes. In particular, the active material is a component of a given layer that has been applied onto the appertaining arrester. Here, the layer advantageously comprises a conductive additive such as electrically conductive carbon black and, for instance, a binder. The metal used for the arrester of the cathode is, for instance, aluminum, and the metal used for the arrester of the anode is copper. In particular, the arresters are configured in the form of a foil and advantageously have a thickness below 0.1 mm.

At least, however, the protruding electrode has the arrester that is provided with the active material, preferably on both sides in the stacking direction. The protruding portion here is at least partially free of the active material, advantageously also free of the remaining components of an additional layer that might be present. For example, here the complete protruding portion is free of the active material and consequently, it is preferably formed essentially only by the arrester. At least, however, the protruding electrode in the area of the thermal contacting with the cooling element is preferably free of the active material and consequently, so is the end of the protruding electrode facing away from the rest of the cell stack. In particular, electric contacting of the arrester with the cooling element takes place here. Preferably, the arrester has a higher heat conductivity in comparison to the active material or other components of a conceivably present layer that comprises the active material, so that the heat dissipation from the cell stack is improved. Since the electrode is free of active material in the area of the protruding portion, especially in the area of the thermal contacting with the cooling element, the thermal resistance between the electrode and the cooling element is relatively low, thus improving the heat dissipation. Therefore, the demand for active material is reduced, thus lowering the production costs. In this context, owing to the distance to the rest of the cell stack, any active material that might be present in the area of the protruding portion does not contribute at all, or else only to a relatively small extent, to providing the capacity.

For example, the protruding electrode is contacted directly with the cooling element. Consequently, relatively few components are required, which is why the production costs are reduced. Especially preferably, however, the protruding electrode is contacted with the cooling element via a contacting element. If several of the electrodes are protruding, they are advantageously contacted with the cooling element via the contacting element, so that a single contacting element is present for all of the protruding electrodes. In other words, the battery only has a single contacting element, an aspect that reduces the production costs. The contacting element is advantageously made of a metal which, for instance, is electrically conductive. Therefore, the protruding electrodes are set to the same electric potential via the contacting element. Consequently, all of the protruding electrodes also have essentially the same temperature. The contacting element, in turn, is thermally contacted with the cooling element. Therefore, it is possible to adapt the cooling element to certain requirements, for instance, to a heat dissipation to the outside or to other prerequisites. In this context, the thermal contacting of the cooling element with the protruding electrodes takes place via the contacting element so that the cooling element and especially the material can be selected and produced independently of the material of the protruding electrodes. Moreover, it is possible to select relatively large manufacturing tolerances for the protruding electrodes and the cooling element, whereby the tolerance compensation is done via the contacting element. This reduces the production costs.

For instance, the contacting element is a spring sheet metal that consequently is highly elastically deformable. The tolerance compensation is improved as a result. Especially preferably, the spring sheet metal comprises a body that is configured, for instance, to be flat or strip-like. It is advantageously arranged perpendicular to the protruding electrode and/or parallel to the stacking direction. This allows several protruding electrodes to be contacted with the body. Preferably, the protruding electrode or all of the protruding electrodes are mechanically in contact with the body. Thus, the body serves to establish the thermal and/or electric contacting with the protruding electrodes. Moreover, the spring sheet metal comprises a springy contactor, advantageously several springy contactors. These are especially arranged between the body and the cooling element and are supported on them. Consequently, the contactor creates the tolerance compensation, which can be implemented relatively inexpensively. In this context, the body, for example, due to its geometric design, can be configured so as to be relatively stable, so that there is always physical contact with the protruding electrode.

For instance, the cooling element is configured so as to be planar on the side facing the cell stack. This simplifies the production. Especially preferably, however, the cooling element has an undulating or jagged configuration on the side facing the cell stack, thus displaying a varying distance from the cell stack. In particular, the distance of the cell stack from the cooling element is reduced in the area of the protruding electrode and consequently the cooling element has a jagged or undulating configuration. This ensures that the protruding electrode is always in thermal contact with the cooling element due to the reduced distance, and preferably mechanically in contact with it. Due to the adjacent greater distance that is created by means of the jagged or undulating configuration, there is a compensation area into which the protruding portion can deflect, even in the case of an excessively enlarged protruding electrode, for example, in case of relatively large manufacturing tolerances. This prevents an uncontrolled buckling of the protruding electrode so that no electric short circuit occurs. This increases the operating safety. If the contacting element is present, the body of the contacting element here preferably has an undulating or jagged configuration. In summary, the cooling element and/or the body of the contacting element thus has an undulating or jagged configuration in the area of the physical contact or at least in the area of the thermal contacting. For instance, owing to the jagged configuration, the cross section of the cooling element along the stacking direction is serrated along the stacking direction or else it has several consecutive serrations.

Especially preferably, the battery comprises a housing that is made, for instance, of a metal. In particular, the housing is made of aluminum or stainless steel, for example, by means of deep drawing. For example, the housing is a pouch housing. The cell stack is arranged in the housing and is therefore protected at least partially by it. For instance, the cooling element is likewise arranged inside the housing. Especially preferably, however, the cooling element is formed by means of a wall of the housing, especially by means of the bottom. In this manner, relatively few components are necessary, thus reducing the weight and production costs. This also facilitates dissipation to the environment of the heat released to the cooling element.

Preferably, the battery comprises one or more electric connections, suitably at least two, which are electrically connected to the cell stack. For instance, here one of the electric connections is electrically contacted with all or at least with some of the remaining electrodes via a busbar arranged inside the housing. The other connection is electrically contacted directly with the housing and, via that, with the protruding electrodes. As an alternative to this, the connection is additionally electrically contacted inside the housing with the protruding electrodes, for instance, via another busbar, or else via the contacting element that might be present. In this case, for example, this connection is also electrically contacted with additional remaining electrodes. In this context, the connections are preferably installed on the side of the housing that faces away from the wall and that forms the cooling element. As a result, the volume of the cooling element is increased and consequently the heat dissipation is improved.

Especially preferably, the battery additionally comprises a cooling plate that is in contact with the wall, for instance, directly or else via other components. The cooling plate is preferably thermally contacted with the wall. Thus, the wall is cooled off via the cooling plate during operation so that the battery can be operated with relatively large losses over a prolonged period of time. The wall here is especially arranged between the cooling plate and the cell stack, in other words, the cooling plate is positioned outside of the housing. As a result, dissipation of the heat to the environment is improved. For instance, the cooling plate has cooling channels for a cooling fluid, for example, a coolant. As an alternative or in combination with this, the cooling element encompasses several ribs that serve to enlarge the surface.

The battery module is, for example, a component of the motor vehicle such as a truck, a bus or a passenger car. The battery module comprises several batteries, for instance, two, three, four or more batteries. Preferably, the number of batteries is less than 100 batteries or 50 batteries. Each battery comprises a cell stack that has layers stacked above each other in a stacking direction. In this context, the layers alternately consist of an electrode or of a separator, and at least one of the electrodes that is arranged between the ends of the cell stack protrudes beyond the remaining electrodes of the appertaining battery perpendicular to the stacking direction. The protruding electrode is thermally contacted with a cooling element of the appertaining battery that is arranged parallel to the stacking direction and next to the cell stack. The cooling element is formed by means of a wall of a housing of the appertaining battery, whereby the wall is in contact with a cooling plate. Here, the wall is arranged between the cooling plate and the cell stack. Preferably, the stacking direction of all of the batteries with respect to each other is the same, and the cooling plates are on the same side relative to the cell stack. In particular, the cooling plates are configured to be cuboidal. Preferably, the cooling plates are formed in one single piece with each other, thus facilitating their production. For instance, the cooling plate is formed by a part of the battery module housing such as the bottom of the battery module housing. For example, the housings of the individual batteries are mechanically directly in contact with each other, thus reducing the space requirements. Therefore, all of the batteries have essentially the same temperature.

The invention also relates to a motor vehicle that is preferably a land vehicle. For instance, the motor vehicle is a utility vehicle such as a truck or bus. Preferably, the motor vehicle is a passenger car. The motor vehicle has a drive with an electric motor. For instance, the drive is a component of an auxiliary aggregate or especially preferably it is a main drive for the locomotion of the vehicle. Moreover, the motor vehicle comprises a battery by means of which the electromotor is supplied with power. The battery comprises a cell stack that has layers stacked above each other in the stacking direction, whereby the layers alternately consist of an electrode or of a separator. At least one of the electrodes arranged between the ends of the cell stack protrudes beyond the remaining electrodes on one side perpendicular to the stacking direction and is thermally contacted with a cooling element that is arranged parallel to the stacking direction and next to the cell stack. Especially preferably, the motor vehicle comprises several such batteries that are components of a battery module by means of which the electric motor is supplied with power. Suitably, the batteries here each have the cooling plates that are formed in one single piece with each other.

The advantages and embodiments cited in conjunction with the battery can also be correspondingly applied to the battery module and/or to the motor vehicle in combination with each other and vice versa.

### BRIEF DESCRIPTION OF THE DRAWINGS

Embodiments of the invention will be explained in greater detail below on the basis of a drawing. The following is shown:

FIG. 1: a schematically simplified view of a motor vehicle having a high-voltage battery with several identical battery modules,

FIG. 2: portions of a schematic sectional view of one of the battery modules having several identical batteries which each have a cell stack,

FIGS. 3-8: in each case, a sectional view of different embodiments of the battery, and

FIG. 9: portions of a schematic sectional view of another embodiment of the battery.

Parts that correspond to each other are designated by the same reference numerals in all of the figures.

### DETAILED DESCRIPTION OF THE INVENTION

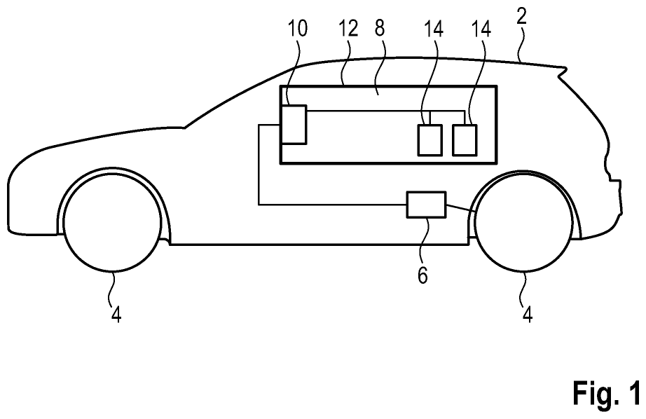

FIG. 1 shows a schematically simplified view of a motor vehicle 2 in the form of a passenger car. The motor vehicle 2 has a number of wheels 4 of which at least some are powered by means of a drive 6 comprising an electric motor. Thus, the motor vehicle 2 is an electric vehicle or a hybrid vehicle. The drive 6 has a converter by means of which the electric motor is supplied with power. The converter of the drive 6, in turn, is supplied with power by means of an energy storage means 8 in the form of a high-voltage battery. For this purpose, the drive 6 is connected to an interface 10 of the energy storage means 8 that is installed in an energy storage housing 12 of the energy storage means 8, said housing 12 of the energy storage means being made of a noble metal. Multiple battery modules 14 are arranged inside the housing 12 of the energy storage means, some of which are electrically connected to each other in series and these, in turn, are electrically connected to each other in parallel. The electric assembly of the battery modules 14 is electrically contacted with the interface 10 so that, during operation of the drive 6, the battery modules 14 are discharged or charged (recuperation). Owing to the electric interconnection, the electric voltage, amounting to 400 V, which is supplied at the interface 10, is a multiple of the electric voltage supplied with each of the identically designed battery modules.

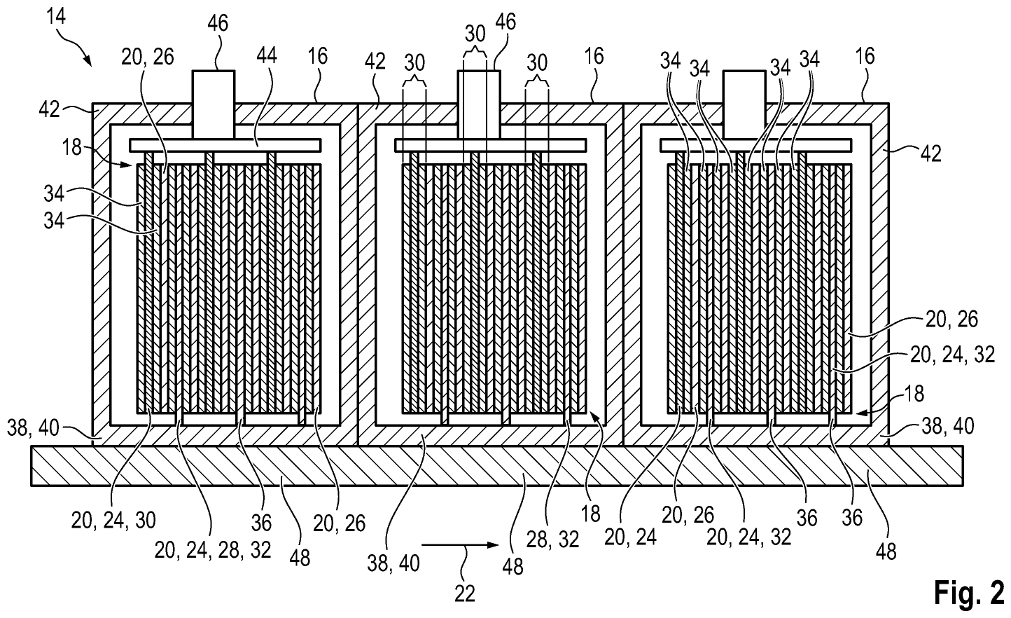

FIG. 2 shows portions of a schematic sectional view of one of the battery modules 14. The battery module 14 comprises several batteries 16 that are identical to each other, three of which are depicted here. In a manner not shown here, some of the batteries 16 are electrically connected to each other in parallel and otherwise electrically connected in series, so that the electric voltage supplied by means of each battery module 14 corresponds to a multiple of the electric voltage supplied by means of one of the batteries 16. Each battery 16 comprises a cell stack 18 that has several layers 20 that are stacked above each other in a stacking direction 22. The stacking direction 22 is the same for all of the batteries 16 and parallel to the sectional line of the sectional depiction. The batteries 16 are also arranged so as to be in contact with each other in the stacking direction 22.

The layers 20 are configured so as to be flat and planar as well as arranged perpendicular to the stacking direction 22. Each of the layers 20 here is essentially rectangular. Each cell stack 18 has between 140 and 200 such layers 20, of which only some are shown here. Each of the layers 20 is formed either by an electrode 24 or by a separator 26, and the separators 26 and the electrodes 24 are alternately arranged in the stacking direction 22. The electrodes 24 are divided into anodes 28 and cathodes 30 which are likewise alternately arranged in the stacking direction 22, so that one of the cathodes, as the appertaining electrode 24, follows one of the anodes 28 in the stacking direction 22 and vice versa. The electrodes 24 each have an arrester 32 that is made of a metal foil. In the case of the anode 24, this is a copper foil and, in the case of the cathode 30, it is an aluminum foil. In the stacking direction 22, both sides of the arrester or arrester foils are provided with a layer 34 containing an active material such as NMC which additionally comprises a binder and a conductive additive such as electrically conductive carbon black. Therefore, the cell stack 18 structured in this manner has several battery cells, whereby each battery cell is associated with one of the anodes 28 and with one of the cathodes 30 that are adjacent to each other in the stacking direction 22. Moreover, each battery cell is associated with one or two of the separators 26.

All of the anodes 28 are lengthened on one side perpendicular to the stacking direction 22 relative to the remaining electrodes 24, namely the cathodes 30, so that these are positioned relative to the remaining electrodes 24. Consequently, every second electrode 24 in the stacking direction 22 protrudes on one side beyond the remaining electrodes 24, namely the cathodes 30, perpendicular to the stacking direction 22, thereby forming a protruding portion 36. In other words, the anodes 28 form the protruding electrodes while the cathodes 30 form the remaining electrodes. Since all of the anodes 28 form the protruding electrodes, some of the electrodes 24 arranged between the ends of the cell stack 18 also have the protruding portion 36 perpendicular to the stacking direction 22 on one side relative to the remaining electrodes, namely, the cathodes 30.

Each protruding portion 36 is free of the layer 34 and is formed only by the appertaining arrester 32. For this reason, each protruding portion 36 is free of the active material. At the end of each protruding portion 36, that is to say, on the side opposite from the rest of the cell stack 18, said protruding portion 36 is electrically and consequently also thermally contacted with a cooling element 38. The cooling element 28 is formed by a wall 40 that is configured so as to be planar and flat, namely, the bottom of an essentially cuboidal housing 42 of the appertaining battery 16. In this context, the appertaining cell stack 18 is arranged inside the appertaining housing 42, and the wall 40 is arranged parallel to the stacking direction 22. As a result, the wall 40 is arranged next to the cell stack 18. The housings 42 are configured so as to be closed and are each made of metal. In an embodiment variant, the housings 42 are configured as pouch housings and are at least partially made of a metal foil.

Inside each housing 42, there is also a busbar 44 that is electrically contacted with a connection 46. The connection 46 penetrates all the way through the housing 42 and is electrically insulated vis-à-vis the housing. The busbar 44 is electrically contacted with all of the cathodes 30, which have an appropriate connection tab for this purpose. Each battery 16 also comprises an additional connection (not shown here) that is electrically directly contacted with the housing 42 and that, like the connection 46, is situated on the side of the housing 42 opposite from the wall 40. Therefore, this connection is electrically contacted with the anodes 28. Energy is drawn from the battery 16 via the connection 46 as well as via the additional connection not shown here.

Each battery 16 also comprises a cooling plate 48, whereby all of the cooling plates 48 of the batteries 16 of the same battery module 14 are configured in one single piece with each of them and by means of the bottom or another wall of a battery module housing. In this context, the cooling plates 48 are situated on the outside of the appertaining wall 40. In other words, the wall 40 of each battery 16 is arranged between the appertaining cell stacks 18 and the cooling plate 48, and each of the housings 42 protrudes beyond the wall of the battery module housing that forms the cooling plates 48. In the case of another one of the walls of the housing 42 that delimits the housing 42 in the stacking direction 22, at least some of the individual housings 42 are in contact with each other, so that the battery module 14 is rendered more compact.

Electric energy is fed in or drawn from the batteries 16 during operation of the battery module 14, so that the appertaining cell stack 18 heats up. It is via the protruding electrodes, in other words, the anode 28, that heat is dissipated from the cell stack 18 to the cooling element 38, namely, to the wall 40 of the appertaining housing 42, and from there to the cooling plate 48, in other words, to the housing of the battery module 14, which is cooled by means of a cooling apparatus not shown here. This translates into a relatively efficient cooling of the cell stack 18, and all of the batteries 16 display essentially the same temperature.

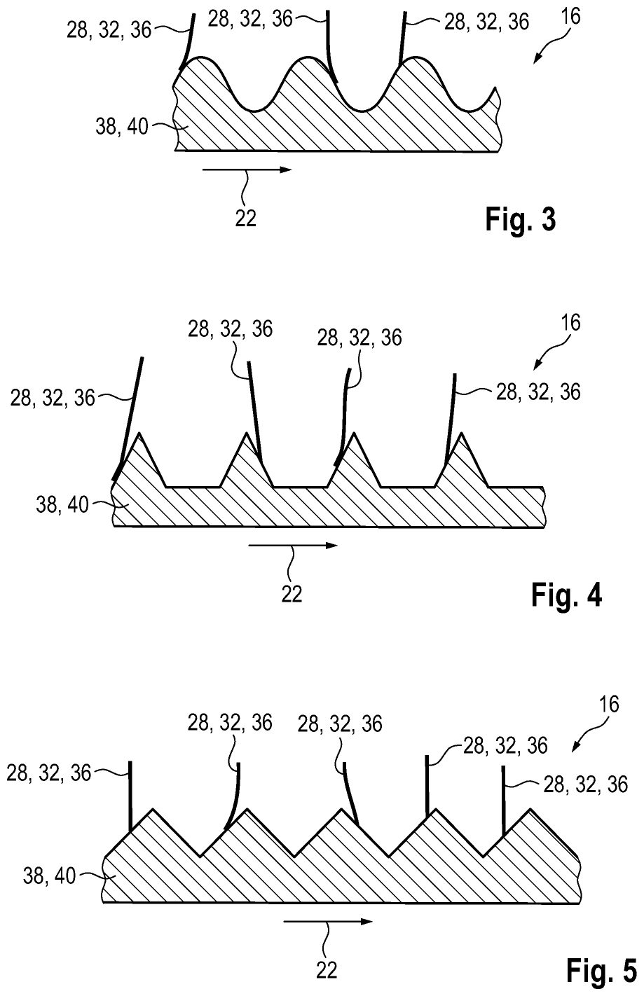

FIG. 3 shows portions of a schematic sectional view along the stacking direction 22 pertaining to another embodiment of the battery 16. In this case, the side, that is to say, the surface, of the walls 40 facing the cell stack 18 is configured so as to be undulating, so that the distance of the wall 40 to the cell stack 18 varies. As a result, the arrester 32 of the anode 28 can be made with a relatively large manufacturing tolerance, so that the size of the protruding portion 36 varies. The wave peaks here are in the position where the anodes 28 are located. Due to the undulating configuration, each arrester 32 is mechanically and thus thermally and electrically securely in contact with the wall 40, even in view of the relatively large manufacturing tolerance, whereby, in the case of an enlarged protruding portion 36, the free end enters one of the adjacent wave valleys and its entire surface is in contact with the wall 40. This prevents an uncontrolled bending of the foil that forms the arrester 32. Moreover, this also establishes a relatively large flat physical contact between the arrester 32 and the wave flanks of the wall 40, thus improving the heat dissipation.

FIG. 4 shows another alternative corresponding to FIG. 3. In this context, the side of the wall 40 facing the cell stack 18 is configured so as to be jagged and formed by means of jags adjacent to each other. In other words, the cross section along the stacking direction 22 is triangular, whereby the individual triangles are at a distance from each other. The tips of the triangles here are located at the desired position of the anode 28. This allows an appropriate tolerance compensation, bringing about a relatively full-surface contact of the individual arresters 32 with the wall 40.

FIG. 5 shows another alternative of the battery corresponding to FIGS. 3 and 4. Here, too, the wall 40 is configured so as to be jagged, whereby the cross section along the stacking direction 22 likewise has triangles which, however, are directly adjacent to each other. As a result, the tips of the triangles do not necessarily have to be situated at the position of the anodes 28 in order to establish the contact.

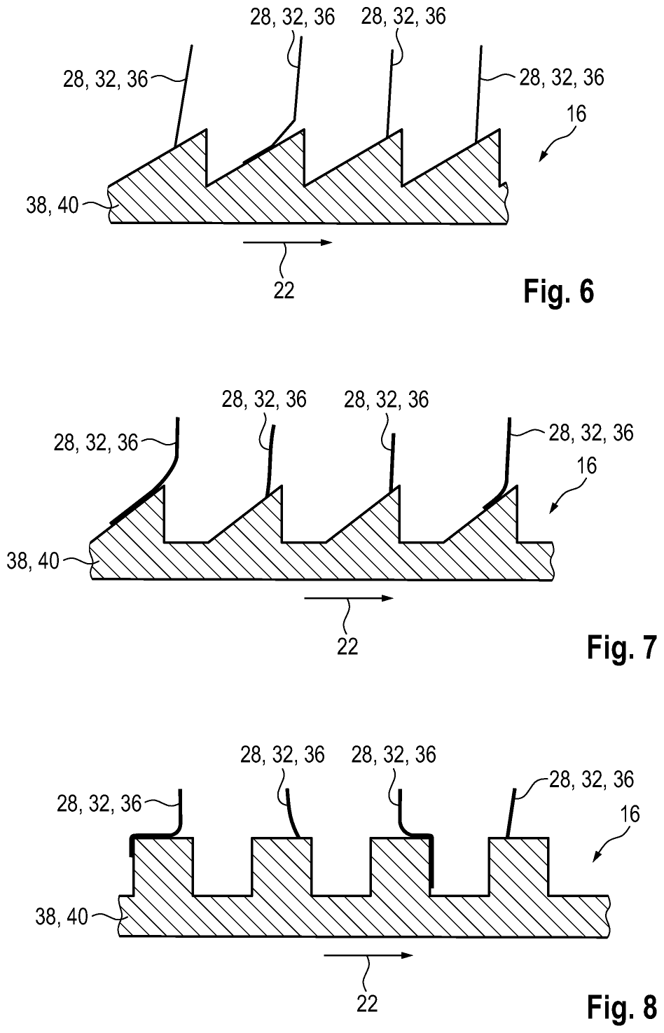

In the variant shown in FIG. 6, the cross section of the wall 40 that forms the cooling element 38 is serrated along the stacking direction 22 on the side facing the cell stack. Due to the ramps that are formed, the wall 40 successively approaches the cell stack 18, so that there is always contact with the arresters 32.

In the variant shown in FIG. 7, the individual serrated teeth are at distance from each other in comparison to the case in FIG. 6, so that the flanks of the serrated teeth are configured more steeply. Consequently, the contact surface is further enlarged.

In the variant shown in FIG. 8, the side of the wall 40 facing the cell stack 18 has individual steps. If the protruding portion 36 is configured so as to be relatively large, it passes around the step. This ensures a relatively large surface area of contact with the wall 40, whereby, however, undesired detachment can occur in the area of the individual edges of the steps.

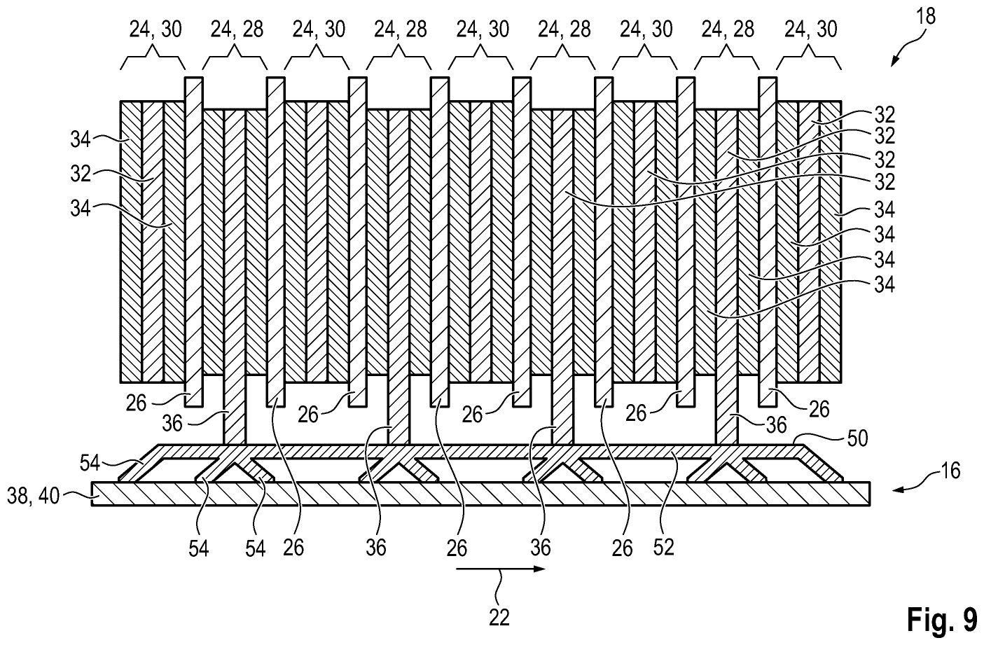

FIG. 9 shows a sectional view along the stacking direction 22 of a last embodiment of the battery 16. The cell stack 18, in turn, has the electrodes 24, namely, the anodes 28 as well as the cathodes 30, which alternate in the stacking direction 22. The electrodes 24, in turn, each have the arrester 32 that is formed by the appertaining foil and that is provided with the layer 34 on both sides relative to the stacking direction 22. Moreover, the arrester 32 of the anode 28 also forms the protruding portion 36 on the side facing the cooling element 38, in other words, facing the wall 40. Between the anode 28 and the cathodes 30, there are, in turn, separators 26 which, however, protrude on at least one side beyond the remaining electrodes, that is to say, the cathodes 30. In this context, the separators 26 also protrude all around or at least on one side beyond the side of the cell stack 18 opposite from the wall 40. In summary, the separators 26 that are directly adjacent to the protruding electrodes, in other words, the anode 28, protrude beyond the remaining electrodes, in other words, the cathodes 30, at least on one side. Consequently, the separators 26 prevent the active material of the cathodes 30 from accumulating on the anodes 28, namely, on the protruding portion 36.

Moreover, the protruding portions 36 are not mechanically, electrically and thermally contacted with the wall 40 directly, but rather via a contacting element 50 that is made in one single piece out of a spring sheet metal. The contacting element 50 has a flat body 52 that is arranged parallel to the wall 40 and that is situated between the cell stack 18 and the wall 40. The body 52 is supported on the wall 40 and thus on the cooling element 38 by means of several springy contactors 54. The contactors 54 are formed in one single piece with the body 52 and the contacting element 50 is configured as a stamped-bent part. The protruding portions 36 are mechanically and directly in contact with the body 52 and are consequently electrically and thermally contacted with the contacting element 50. The contactors 54 bring about physical contact of the contacting body 52 with the cooling element 38, so that the contacting body 52 is thermally and electrically contacted with the cooling element 38. Consequently, the protruding electrodes, namely, the anodes 28, are electrically and thermally contacted with the cooling element 38.

In a variant not shown here, the variants depicted in FIGS. 2 to 8 have protruding separators 26. In other variants not shown here, in the variant depicted in FIG. 9, the wall 40 is configured according to the embodiment depicted in FIGS. 3 to 8. In other variants not shown here, the body 52 is accordingly shaped on the side facing the cell stack 18 corresponding to the side of the wall 40 shown in FIGS. 3 to 8.

The invention is not limited to the embodiments described above. Rather, other variants of the invention can also be derived by the person skilled in the art without departing from the subject matter of the invention. In particular, all of the individual features described in conjunction with the individual embodiments can also be combined in another manner without departing from the subject matter of the invention.

### LIST OF REFERENCE NUMERALS

2 motor vehicle

4 wheel

6 drive

8 energy storage means

10 interface

12 housing of the energy storage means

14 battery module

16 battery

18 cell stack

20 layer

22 stacking direction

24 electrode

26 separator

28 anode

30 cathode

32 arrester

34 layer

36 protruding portion

38 cooling element

40 wall

42 housing

44 busbar

46 connection

48 cooling plate

50 contacting element

52 body

54 contactor

1. A battery comprising:
a cell stack that encompasses layers stacked above each other in a stacking direction,
whereby the layers consist alternately of an electrode or of a separator,
whereby at least one of the electrodes that is arranged between the ends of the cell stack protrudes beyond the remaining electrodes on one side perpendicular to the stacking direction, and
said protruding electrode is thermally contacted with a cooling element that is arranged parallel to the stacking direction and next to the cell stack.

2. The battery according to claim 1, wherein every second electrode in the stacking direction protrudes on one side beyond the remaining electrodes perpendicular to the stacking direction, and said protruding electrode is thermally contacted with the cooling element.

3. The battery according to claim 1, wherein the separators that are directly adjacent to the protruding electrode protrude beyond the remaining electrodes on one side.

4. The battery according to claim 1, wherein the protruding electrodes comprise a metal arrester that is provided with an active material, whereby the protruding portion is at least partially free of the active material.

5. The battery according to claim 1, wherein the protruding electrode is contacted with the cooling element via a contacting element.

6. The battery according to claim 5, wherein the contacting element is a spring sheet metal with a body with which the protruding electrode is mechanically in contact and which is supported on the cooling element by means of a springy contactor.

7. The battery according to claim 1, wherein the cooling element has an undulating or jagged configuration on the side facing the cell stack.

8. The battery according to claim 1, further comprising a housing in which the cell stack is arranged, whereby the cooling element is formed by means of a wall of the housing.

9. The battery according to claim 8, further comprising a cooling plate that is in contact with the wall, whereby the wall is arranged between the cooling plate and the cell stack.

10. A battery module having several batteries according to claim 9, whereby the cooling plates are formed in one single piece with each other.
